(19) United States
(12) Patent Application Publication
(10) Pub. No.: US 2004/0080789 A1
(43) Pub. Date: Apr. 29, 2004

(54) Gray scale enhancements for color documents rendered on monochrome devices

(76) Inventor: James E. Anderson, Meridian, ID (US)

Correspondence Address: HEWLETT-PACKARD COMPANY, Intellectual Property Administration, P.O. Box 272400, Fort Collins, CO, 80527-2400, US

(21) Appl. No.: 10/281,933

(22) Filed: Oct. 28, 2002

(51) Int. Cl. H04N 1/407; H04N 1/409; G06T 5/00

(52) U.S. Cl. 358/2.1; 358/3.27; 382/266; 382/274; 358/3.21

(57) ABSTRACT

Gray scale data converted from color data is enhanced prior to being rendered on a monochrome device. Different enhancements are applied to different image types based on selected monochrome output options. The enhancements to the gray scale data make close shades of gray more easy to distinguish. Advantages of the disclosed system and methods include improved gray scale documents that better convey visual information present in an original color document.

### TECHNICAL FIELD

The present disclosure relates to printing and copying color documents, and more particularly, to improving the appearance of color documents that are printed or copied on monochrome printers or copiers.

### BACKGROUND

The use of color documents has become commonplace in many environments. The flexibility, variety, and aesthetic qualities that color documents can provide make them valuable in many areas, such as in business settings, educational settings and home office settings. For example, a presentation that includes visually exciting color documents may be of great benefit to a salesperson pitching a new product. A periodic table of elements printed in color, as opposed to black and white, can increase the educational benefits of a teacher's chemistry lesson. A father can print a color photo of his new son to pin up in his office. Because of the many benefits that color documents offer, their use continues to grow.

Computer users who create and work with color documents, however, typically have much less access to color printers than to monochrome printers (i.e., black and white printers). Therefore, color documents are often printed on monochrome printers. In a similar way, because monochrome copiers are more prevalent than color copiers, color documents are often copied in black and white on monochrome copiers.

There are disadvantages to printing/copying color documents using monochrome (i.e., black and white) printers/copiers. In general, distinctions between different colors that are easily recognized in the color version of a document can be significantly reduced, or even lost, when that same document is printed or copied in black and white. For example, in a color document having text that is highlighted in a bright color, the text stands out when the document is printed in color. However, the same text often looks non-highlighted or even obscure when the document is printed in black and white on a monochrome printer. Variously colored elements in a color graph or chart may be easily distinguishable when the graph or chart is printed in color, but they may be much less distinguishable if the graph or chart is printed in black and white on a monochrome printer. Text on a color background may look perfectly fine when a document is printed in color, but may be very difficult to read if the document is printed in black and white on a monochrome printer. These examples apply in a similar way when color documents are copied on monochrome copiers.

The loss of definition between colors when printing/copying color documents in black and white is related to the conversion of the colors into their gray scale equivalent shades. Typical gray scale conversion algorithms convert colors into gray scale equivalents based on the strength or intensity of the colors. Thus, blues typically convert to a darker gray scale shade, while greens convert to a medium gray scale shade, and yellows convert to a lighter gray scale shade. However, various colors have gray scale equivalents that are very similar. Therefore, certain colors that are easy to distinguish when printed in color, may be almost indistinguishable when printed in their gray scale equivalent shades on a monochrome printer. For example, yellow and light green are easy to distinguish when printed in color. However, the equivalent gray scale shades for yellow and light green are almost indistinguishable. Therefore, the distinction between these two colors is lost when a color document is printed in black and white.

Accordingly, the need exists for a way to maintain distinctions between colors and generally improve the readability of color documents when printing and copying such documents in black and white on monochrome devices (i.e., monochrome printers and copiers).

### SUMMARY

Gray scale data converted from color data is enhanced according to various image types and monochrome output instructions.

In a particular embodiment, a printer receives color data and instructions on how to output the color data in monochrome. The printer converts the color data to gray scale data. The printer also distinguishes different image types, such as text, bitmap, or graphics, that may be present within the data. The printer applies the monochrome output instructions to the different image types, and enhances the gray scale data for each image type accordingly.

In another embodiment, a print command is initiated from within an application program. Color print data is received in an application program format, and options are presented for how to enhance the monochrome output of various image types. The color print data is formatted into printer-friendly data having one or more image types. The printer-friendly data and user-selected monochrome output options are sent to a printer.

### BRIEF DESCRIPTION OF THE DRAWINGS

The same reference numbers are used throughout the drawings to reference like components and features.

FIG. 1 illustrates a system environment suitable for implementing gray scale enhancements for a color document being rendered on a monochrome device.

FIG. 2 is a block diagram illustrating in greater detail, an exemplary embodiment of an input device and a printing device that are suitable for implementation in the system environment shown in FIG. 1.

FIG. 3 illustrates an example of gray scale enhancement options available with a text image type.

FIG. 4 illustrates an example of gray scale enhancement options available with a text on a background image type.

FIG. 5 illustrates an example of gray scale enhancement options available with a vector graphics image type.

FIG. 6 illustrates an example of gray scale enhancement options available with a bitmap image type.

FIG. 7 is a block diagram illustrating in greater detail, an additional exemplary embodiment of an input and printing device that are suitable for implementation in the system environment of FIG. 1.

FIG. 8 is a block diagram illustrating in greater detail, a stand-alone copier device that is suitable for implementation in the system environment of FIG. 1.

FIG. 9 is a flow diagram illustrating an example method of implementing gray scale enhancements for color documents being rendered on monochrome devices.

FIG. 10 is a continuation of the flow diagram of FIG. 9 illustrating an example method of implementing gray scale enhancements to a bitmap image type.

FIG. 11 is a continuation of the flow diagram of FIG. 9 illustrating an example method of implementing gray scale enhancements to a vector graphics image type.

FIG. 12 is a continuation of the flow diagram of FIG. 9 illustrating an example method of implementing gray scale enhancements to a text image type.

FIG. 13 is a continuation of the flow diagram of FIG. 9 illustrating an example method of implementing gray scale enhancements to a text on a background image type.

### DETAILED DESCRIPTION

Gray scale data converted from color data is enhanced prior to being rendered on a monochrome device. Different enhancements are applied to different image types based on selected monochrome output options. The enhancements to the gray scale data make close shades of gray more easy to distinguish. Advantages of the disclosed system and methods include black and white versions of color documents that better convey the distinctions between colors that are apparent in the original color documents.

Exemplary System Environment For Implementing Gray Scale Enhancements For Color Documents Rendered On Monochrome Devices

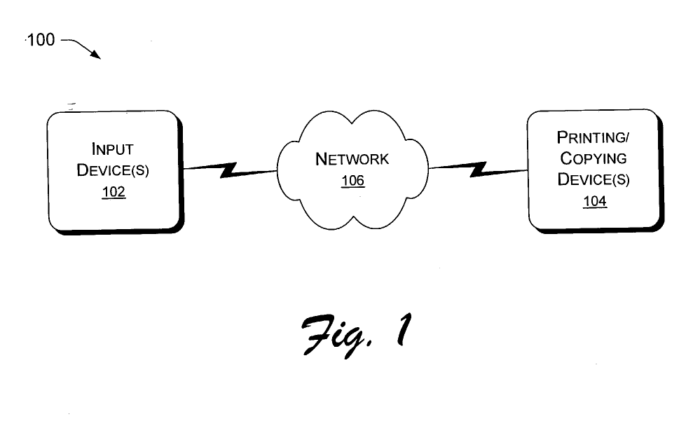

FIG. 1 illustrates an example of a system environment 100 suitable for implementing gray scale enhancements when rendering color documents on monochrome devices. The system 100 includes input device(s) 102, printing/copying device(s) 104, and a communication network 106 operatively coupling input device(s) 102 to printing/copying device(s) 104. The communication network 106 can include both local and remote connections depending on the particular system configuration. Thus, network connection 106 may include, for example, a printer cable, a LAN (local area network), a WAN (wide area network), an intranet, the Internet, and other such suitable communications links. Network connection 106 can also include wireless communications links such as IR (infrared) or RF (radio frequency) links. Network connection 106 can also include a direct connection between two components of a single device, such as between a scanning component and a printing component within a single copy machine, where the scanning component represents input device 102 and the printing component represents printing/copying device 104.

Input device(s) 102 can be implemented as a variety of general purpose computing devices including, for example, a personal computer (PC), a laptop computer, a Macintosh, a workstation computer, a scanner, and other devices configured to communicate with printing/copying device(s) 104. An input device 102 typically provides a user with the ability to manipulate or otherwise prepare in electronic form, an image or document that can be rendered as an image that is printed or otherwise formed onto a print medium by a printing/copying device 104 after transmission over network 106. In general, input device 102 provides data in a printer-friendly format to printing device 104 which converts the data and outputs it onto an appropriate recording media, such as paper or transparencies.

Printer-friendly data is data from an application program that has been reformatted into a PDL (page description language) format by a printer driver located on input device 102. The application program data is formatted into a PDL format suitable for printing device 104, such as PCL or PostScript, prior to being sent to printing device 104. The printer-friendly data (i.e., PDL) typically includes image data of various types including, for example, text, vector graphics and bitmaps. In addition, data from input device 102 can include instruction data that contains processing instructions for how printing device 104 is to process data from input device 102.

Printing/copying device(s) 104 can include various types of monochrome (i.e., black and white) printing/copying devices, or color printing devices that can print in monochrome, such as printers that are capable of rendering PDL formatted data in printed form on a print medium, such as printing pixels on paper. Therefore, printing/copying device(s) 104 can include devices such as laser-based printers, ink-based printers, dot matrix printers, dry medium printers, plotters and the like. In addition, printing/copying device(s) 104 might also include various multi-function peripheral (MFP) devices that combine a printing function with other functions such as facsimile transmission, scanning, copying and the like. Furthermore, although printing/copying device 104 is illustrated as a networked device, it might also be a stand-alone monochrome copying device with a color input device (e.g., a scanner).

In general, a printer 104 receives input data as a print job transmitted by an input device 102 over network 106. Printer 104 is configured to render the print job as a black and white (i.e., gray scale) hard copy image document formed on various print media. Prior to rendering the print job onto print media, printer 104 may also process the print job to effect various outcomes in the printed image. For example, as discussed in greater detail below, printer 104 may apply one or more enhancements to gray scale data. Alternatively, a stand-alone copier 104 may receive input data in the form of a color document placed on a copier platen, and process the data in a similar manner to effect various outcomes in the copied image.

Exemplary Embodiments For Implementing Gray Scale Enhancements For Color Documents Rendered On Monochrome Devices

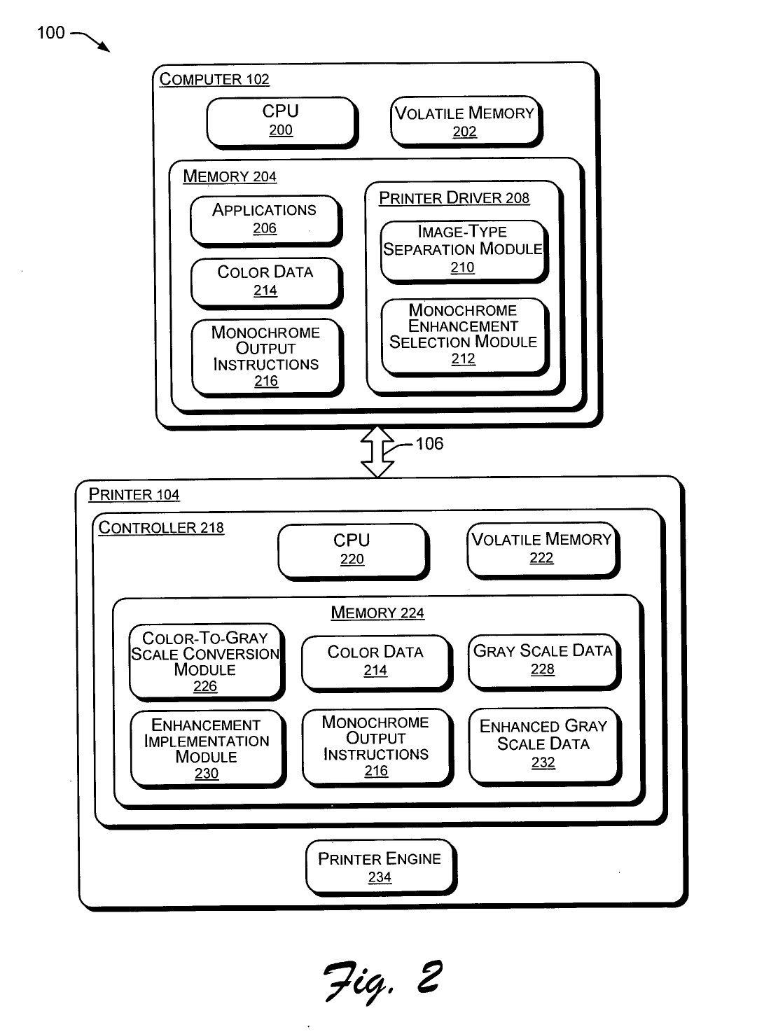

FIG. 2 is a block diagram illustrating in greater detail, an exemplary embodiment of devices suitable for implementation in the system environment 100 of FIG. 1. Input device 102 is embodied as a computer 102, and printing/copying device 104 is embodied as monochrome printer 104. Computer 102 and printer 104 are operatively coupled through network connection 106. In general, computer 102 and printer 104 operate to render color documents generated or otherwise acquired by computer 102 as black and white hardcopy images that better convey color distinctions through enhanced gray scale equivalent shades.

Computer 102 typically includes a processor 200, a volatile memory 202 (i.e., RAM), and a nonvolatile memory 204 (e.g., ROM, hard disk, floppy disk, CD-ROM, etc.). Nonvolatile memory 204 generally provides storage of computer/processor-readable instructions, data structures, program modules and other data for computer 102. Accordingly, memory 204 includes application programs 206, color data 214, monochrome output instructions 216, and printer driver 208.

Computer 102 may implement various application programs 206 stored in memory 204 and executed on processor 200 that create or otherwise form a document or image (e.g., text and/or graphics) on a computer screen that is transferable over network connection 106 to printer 104 for creating a hard copy of the document/image. Such applications 206 might include software programs implementing, for example, word processors, spread sheets, browsers, multimedia players, illustrators, computer-aided design tools and the like.

Computer 102 may also implement one or more software-based device drivers such as printer driver 208 that are stored in nonvolatile memory 204 and executed on processor 200. Device drivers might also be implemented on the specific devices they are “driving” such as printer 104. In general, printer driver 208 formats document information into a PDL (page description language) such as PostScript or Printer Control Language (PCL) or another appropriate format which is output to printer 104.

In the current embodiment, printer driver 208 additionally includes image-type separation module 210 generally configured to receive print data from an application program 206 and format it into various image types, such as text, vector graphics, and bitmaps. Printer driver 208 also includes monochrome enhancement selection module 212 that is configured to present a user with options for enhancing gray scale data for the various image types. Selection module 212 presents an option to have all gray scale enhancement selections made automatically. If a user selects the automatic option, the selection module 212 intelligently applies the various gray scale enhancements based on pre-programmed default settings. If a user chooses to select each enhancement individually, then further enhancement options are provided for each of the various image types (i.e., text, text over a bitmap or vector graphic, vector graphics, and bitmaps). Operation of the image-type separation module 210 and monochrome enhancement selection module 212 is discussed more thoroughly below.

Color data 214 generally represents color document/image data from an application program 206 that has been formatted by printer driver 208 and is being sent to printer 104. Therefore, color data 214 is in a PDL format and has been separated by image-type separation module 210 into various image types for further processing by printer 104. Monochrome output instructions 216 generally represent user-entered selections regarding how the gray scale data representing various image types is to be enhanced on printer 104.

Printer 104 of the FIG. 2 embodiment includes controller 218 that, in general, processes data from computer 102 to control the output of printer 104 through printer engine 234. The controller 218 typically includes a data processing unit/CPU 220, a volatile memory 222 (i.e., RAM), and a nonvolatile memory 224. Nonvolatile memory 224 can include various computer storage media such as ROM, flash memory, a hard disk, a removable floppy disk, a removable optical disk and the like. Nonvolatile memory 224 generally provides storage of computer/processor-readable instructions, data structures, program modules and other data for printer 104.

Accordingly, nonvolatile memory 224 includes color-to-gray scale conversion module 226 that is generally configured to convert color data 214 into gray scale data 228. Thus, various colors within a document represented by color data 214 are converted into their gray scale equivalent shades and stored as gray scale data 228. In addition, nonvolatile memory 224 includes enhancement implementation module 230 that is generally configured to recognize various image types within gray scale data 228, and to enhance the gray scale data according to the monochrome output instructions 216 provided for the various image types and received from computer 102. Gray scale data 228 and enhanced gray scale data 232 are rendered through printer engine 234.

Enhancement implementation module 230 performs various enhancements to gray scale data 228 depending on the image type being represented in the data. The enhancements are generally intended to improve distinctions in color variations for different image types that might otherwise be obscured or lessened when different colors are converted to gray scale equivalent shades. In the current embodiment, enhancement implementation module 230 may perform gray scale enhancements on various image types including text, text over a bitmap or vector graphic, vector graphics, and bitmaps. It is noted that the application of gray scale enhancements as described below is not necessarily limited to the particular image types to which the enhancements are applied. Thus, the described gray scale enhancements may be applicable to other image types currently available but not mentioned. In addition, the enhancements may be applicable to image types that are not yet available but that become available in the future. Furthermore, this disclosure is not intended to limit the extent or variety of gray scale enhancements to those described herein. Rather, the enhancements described herein are provided by way of example.

FIG. 3 illustrates an example of gray scale enhancement options available with a text image type. Documents 300 and 302 both illustrate text that has been printed on a monochrome printer 104 from a color document having color text. As mentioned above, printer driver 208 includes monochrome enhancement selection module 212 that is configured to present a user with options for enhancing gray scale data for various image types. Whether set by the user directly or through an automatic default option, the available gray scale enhancement options for a text image type include: (1) printing the text in the normal gray scale equivalent shade that corresponds to the text color; and (2) printing the text in black. Thus, a color document having color text can be printed on monochrome printer 104 such that the color text is output in a gray scale equivalent shade or in black.

In FIG. 3, the first document 300 represents color text (i.e., color data 214) printed on monochrome printer 104 where the selected enhancement is to print the text in black. Thus, after color text data 214 is converted by color-to-gray scale conversion module into gray scale text data 228, the enhancement implementation module 230 enhances the gray scale equivalent shade (i.e., the gray scale data 228) of the text to make it black. The enhanced gray scale data 232 is rendered as represented by first document 300 of FIG. 3.

The second document 302 of FIG. 3 represents the same color text where the selected enhancement is to print the text in the normal gray scale equivalent shade that corresponds to the original text color. Thus, after color text data 214 is converted by color-to-gray scale conversion module 226 into gray scale text data 228, the enhancement implementation module 230 leaves the gray scale equivalent shade (i.e., the gray scale data 228) of the text to print as normal. The gray scale data 228 is rendered as represented by first document 300 of FIG. 3.

In general, FIG. 3 is intended to illustrate how a gray scale enhancement to a text image type might be used to make the color text as printed on a monochrome printer 104 stand out more clearly.

FIG. 4 illustrates an example of gray scale enhancement options available with a text image type on a background image type. The background image type is either a bitmap or vector graphic. Documents 400 and 402 both illustrate text 404 on a background 406 that has been printed on a monochrome printer 104 from a color document having color text on a color background. Whether set by the user directly or through an automatic default option, the available gray scale enhancement options for a text on a background image type include: (1) increasing the distinction between the normal gray scale shades of the text 404 and normal gray scale shades of the background 406 when these gray scale shades are similar; and (2) leaving the normal gray scale shades alone for the text 404 and background 406. If the second option is selected, the converted gray scale shades (i.e., gray scale data 228) for both the text 404 and the background 406, as converted from original color data 214, are left to be printed as normal. However, if the first option is selected, the enhancement implementation module 230 will automatically execute one of several different enhancement techniques when the gray scale shades for the text 404 and the background 406 are similar.

In general, determining whether two gray scale shades are similar in value involves a comparison of the pixel densities within a particular image area, such as text image areas, graphics image areas and bitmap image areas. For example, if the pixel density within a text 404 image area is “X”, and the pixel density within a background 406 image area is “Y”, then the difference between “X” and “Y” indicates the similarity or difference in the gray scale shades of the text 404 and the background 406. The difference between “X” and “Y” can be compared to a threshold value to determine whether or not enhancements should be applied to the gray scale shades. It is noted that there may be various additional methods for determining whether gray scale shades are similar in value, and that such methods may be appropriate for use in the embodiments described in this disclosure.

Referring again to the FIG. 4 example of gray scale enhancement options, if it is determined that gray scale shades for the text 404 and the background 406 are similar, a first enhancement technique darkens the gray scale shade for the text 404 and lightens the gray scale shade for the background 406. Darkening a gray scale shade involves increasing pixel data density within a desired image area, such as the image area of the text 404. Lightening a gray scale shade involves decreasing pixel data density within a desired image area, such as the image area of the background 406. A second enhancement technique lightens the gray scale shade for the text 404 and darkens the gray scale shade for the background 406. A third enhancement technique darkens the gray scale shade for the text 404 and makes no change to the gray scale shade for the background 406. A fourth enhancement technique lightens the gray scale shade for the text 404 and makes no change to the gray scale shade for the background 406. A fifth enhancement technique makes no change to the gray scale shade for the text 404 and lightens the gray scale shade for the background 406. A sixth enhancement technique makes no change to the gray scale shade for the text 404 and darkens the gray scale shade for the background 406.

Whether the first, second, third, fourth, fifth, or sixth enhancement technique is executed depends on which gray scale shade, the text 404 shade or the background 406 shade, is lighter or darker upon conversion from color data 214, and the degree to which the gray scale shades differ. For example, if the normal gray scale shade of the text 404 is darker than the normal gray scale shade of the background 406, then the text 404 gray scale shade may be enhanced to a darker shade while the background 406 gray scale shade may be left alone or enhanced to a lighter shade. If the normal gray scale shade of the text 404 is already at its darkest shade, however, then the gray scale shade of the text 404 would be left alone while the gray scale shade of the background 406 would be enhanced to a lighter shade.

Document 400 of FIG. 4 illustrates, by way of example, a gray scale version of a color document having color text on a color background that is printed on a monochrome printer 104 where no gray scale enhancements have been made to the text or background image types. Document 400 illustrates the problem that can occur under circumstances where the text 404 and the background 406 convert to gray scale equivalent shades that are similarly dark. The result is that the text 404 is difficult to distinguish. Document 402, however, illustrates a gray scale version of the same color document after a gray scale enhancement, such as one of the six enhancements described above, has been made. The enhancements that may have been applied in this case include, for example, a darkening of the gray scale shade for the text 404 with a lightening of the gray scale shade for the background 406, or just a lightening of the gray scale shade for the background 406 while the gray scale shade for the text 404 is left alone.

FIG. 5 illustrates an example of gray scale enhancement options available with a vector graphics image type. Documents 500 and 502 both illustrate areas within a graphics image type representing graphic components 504 (e.g., bar graphs) that have been printed on a monochrome printer 104 from a color document having color bar graphs. Whether set by the user directly or through an automatic default option, the available gray scale enhancement options for a vector graphics image type include:

(1) increasing the differentiation between gray scale shades for different colored graphic component 504 areas when these gray scale shades are similar; and (2) leaving the gray scale shades of the colored graphic component 504 areas alone. If the first option is selected, the enhancement implementation module 230 adjusts gray scale shades of adjacent graphic components 504 having shades that are similar in value after determining that the colors of the original graphic components 504 are different.

It is noted that the enhancement implementation module 230 adjusts gray scale shades as appropriate even where graphic components 504 are outlined or separated by a line. In addition, where colored legends exist with colors corresponding to colored graphic components 504, adjustments made to gray scale shades of graphic components 504 are likewise made to the corresponding gray scale shades in the legend.

The method described above for determining whether two gray scale shades are similar in value, as well as other applicable methods, may be used to initially determine if gray scale shades for different colored graphic components 504 are similar. In addition, however, prior to applying a gray scale enhancement, the enhancement implementation module 230 first determines whether the colors of the original graphic components 504 are actually different. If the original colors are not actually different, but are instead simply different intensities of the same color, then no gray scale enhancements are applied. Under such circumstances, the difference in gray scale shades of adjacent graphic components 504 would be a correct reflection of the varying intensities of the original colors.

Referring again to the FIG. 5 example, if it is determined that gray scale shades for different graphic components 504 (e.g., bar graphs 504(1) and 504(2)) are similar, and that the colors of the original graphic components 504 are different, various enhancement techniques may be implemented. A first enhancement technique darkens the gray scale shade for a first graphic component (e.g., 504(2)) and lightens the gray scale shade for a second graphic component (e.g., 504(1)). As discussed above, darkening a gray scale shade involves increasing pixel data density within a desired image area, such as the image area of the graphic component 504(1), while lightening a gray scale shade involves decreasing pixel data density within a desired image area, such as the image area of graphic component 504(1).

A second enhancement technique lightens the gray scale shade for the first graphic component and darkens the gray scale shade for the second graphic component. A third enhancement technique darkens the gray scale shade for the first graphic component and makes no change to the gray scale shade for the second graphic component. A fourth enhancement technique lightens the gray scale shade for the first graphic component and makes no change to the gray scale shade for the second graphic component. A fifth enhancement technique makes no change to the gray scale shade for the first graphic component and lightens the gray scale shade for the second graphic component. A sixth enhancement technique makes no change to the gray scale shade for the first graphic component and darkens the gray scale shade for the second graphic component.

Whether the first, second, third, fourth, fifth, or sixth enhancement technique is executed depends on which gray scale shade, that of the first graphic component or that of the second graphic component, is lighter or darker upon conversion from color data 214, and the degree to which the gray scale shades differ. For example, if the normal gray scale shade of the first graphic component (e.g., 504(1)) is lighter than the normal gray scale shade of the second graphic component (e.g., 504(2)), then the gray scale shade of the first graphic component may be enhanced to a lighter shade while the gray scale shade of the second graphic component may be left alone or enhanced to a darker shade.

Document 500 of FIG. 5 illustrates an example of a color document having different colored graphic components 504 that has been printed on a monochrome printer 104, where no gray scale enhancements have been made to the graphic components 504. Document 500 illustrates the problem that can occur under circumstances where the gray scale equivalent shades of the colored graphic components 504 are similar. The result is that the different graphic components 504 are difficult to distinguish from one another. For example, the gray scale shades of graphic components 504(1) and 504(2) are very similar and are difficult to differentiate, while the gray scale shades of graphic components 504(2) and 504(3) are virtually identical and nearly impossible to differentiate.

Document 502, however, illustrates an example of the same color document with colored graphic components 504 printed on a monochrome printer 104 after gray scale enhancements have been made to the graphic components 504. Adjacent graphic components 504 with close gray scale shades have been enhanced in order to increase the differentiation between the shades of each graphic component 504. For example, the gray scale shade of graphic component 504(1) appears to have been lightened, while the gray scale shade of graphic component 504(2) appears to have been darkened. Similar enhancements have been made to the gray scale shades of graphic components 504(3) and 504(4), making the gray scale shades of each of the graphic components more distinguishable.

The result of the gray scale enhancements to the vector graphics image type is that different graphic components 504 with similar gray scale shades that are normally difficult to distinguish (i.e., document 500) can now be more easily distinguished due to the increased differentiation between the gray scale shades of the graphic components 504 (i.e., document 502).

FIG. 6 illustrates an example of gray scale enhancement options available with a bitmap image type. Documents 600 and 602 both illustrate color bitmap images that have been printed on a monochrome printer 104 from a color document. Each bitmap image has two colored areas 604 and 606 whose gray scale equivalent shades are very similar. Whether set by the user directly or through an automatic default option, the available gray scale enhancement options for a bitmap image type include: (1) exaggerating the edges of adjacent areas (e.g., 604, 606) within the bitmap whose gray scale equivalent shades are similar if the corresponding colors in the original color bitmap are different; and (2) leaving adjacent areas (e.g., 604, 606) within the bitmap whose gray scale equivalent shades are similar as normal gray scale shades. If the first option is selected, the enhancement implementation module 230 adjusts gray scale shades along the borders of adjacent bitmap areas (604, 606) having similar gray scale shades after first determining that the colors of the original adjacent bitmap areas (604, 606) are different.

The method described above for determining whether two gray scale shades are similar in value, as well as other applicable methods, may be used to initially determine if gray scale shades for different colored bitmap areas 604 and 606 are similar. In addition, however, prior to applying a gray scale enhancement, the enhancement implementation module 230 first determines whether the colors of the original bitmap areas 604 and 606 are actually different. If the original colors are not actually different, but are instead simply different intensities of the same color, then no gray scale enhancements are applied. Under such circumstances, the difference in gray scale shades of adjacent bitmap areas 604 and 606 would be a correct reflection of the varying intensities of the original colors.

Document 600 of FIG. 6 illustrates a color document having different colored bitmap areas (604, 606) printed on a monochrome printer 104 where no gray scale enhancements have been made to the bitmap areas (604, 606). Document 600 illustrates the problem that can occur under circumstances where the gray scale equivalent shades of the bitmap areas (604, 606) are similar in value. The result is that the different bitmap areas (604, 606) are difficult to distinguish from one another.

Document 602, however, illustrates the same color document printed on a monochrome printer 104 where gray scale enhancements have been made to the adjacent edges 608 and 610 of bitmap areas 604 and 606, respectively. Document 602 is intended to illustrate that adjacent edge 608 of bitmap area 604 has been darkened to exaggerate the fact that area 604 is darker than area 606. Document 602 is also intended to illustrate that adjacent edge 610 of bitmap area 606 has been lightened to exaggerate the fact that area 606 is lighter than area 604.

The result of the gray scale enhancements to the bitmap image type is that different bitmap areas (e.g., 604, 606) with similar gray scale shades that are normally difficult to distinguish (i.e., document 600) can now be more easily distinguished due to the increased differentiation between the gray scale shades at the adjacent edges (e.g., 608, 610) of the bitmap areas (604, 606) (i.e., document 602). As discussed above, gray scale shades are darkened by increasing pixel data density within a desired area, such as the adjacent edge 608 of bit map area 604. Gray scale shades are lightened by decreasing pixel data density within a desired area, such as the adjacent edge 610 of bit map area 606.

FIG. 7 is a block diagram illustrating another exemplary embodiment of an input device 102 and a printing/copying device 104 that are suitable for implementation in the system environment 100 of FIG. 1. Like the embodiment of FIG. 2, input device 102 is embodied as a computer 102, and printing/copying device 104 is embodied as monochrome printer 104. Computer 102 and printer 104 are operatively coupled through network connection 106. In general, computer 102 and printer 104 operate and are configured in a manner similar to that described above with reference to the FIG. 2 embodiment. However, in the current embodiment of FIG. 7, several functional aspects previously performed on the printer 104 are now performed on the computer 102.

Accordingly, the printer driver 208 on computer 102 now includes the enhancement implementation module 230 and color-to-gray scale conversion module 226 that were previously located in printer 104. In addition, memory 204 now includes the gray scale data 228 and enhanced gray scale data 232 that correspond to the added printer driver 208 modules 230 and 226. More specifically, the output of color-to-gray scale conversion module 226 is the gray scale data 228, both of which are now located on computer 102. Similarly, the output of enhancement implementation module 230 is the enhanced gray scale data 232, both of which are now located on computer 102. Note that enhanced gray scale data 232 additionally resides on printer 104 prior to being rendered through printer engine 234.

The result of the current FIG. 7 embodiment is that most of the data processing occurs on the computer 102, and only the enhanced gray scale data 232 needs to be sent to printer 104. The entire discussion above regarding the examples of gray scale enhancements to various image types in FIGS. 3-6 applies similarly to the FIG. 7 embodiment.

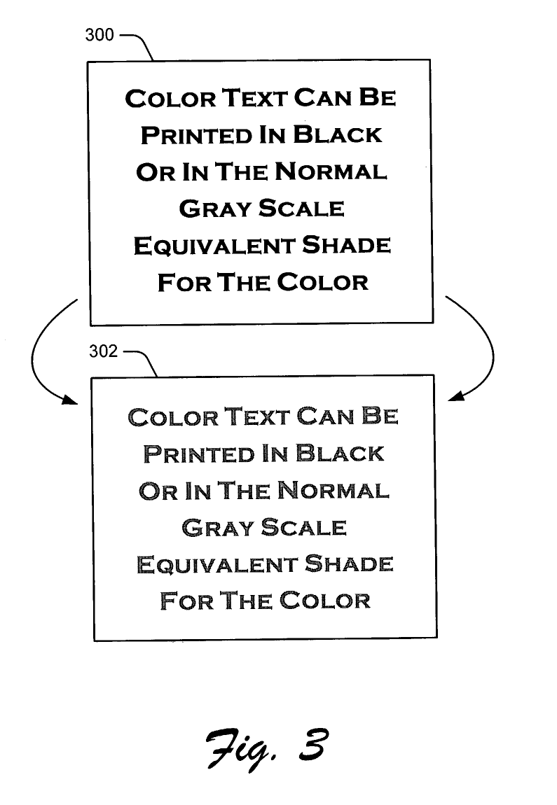

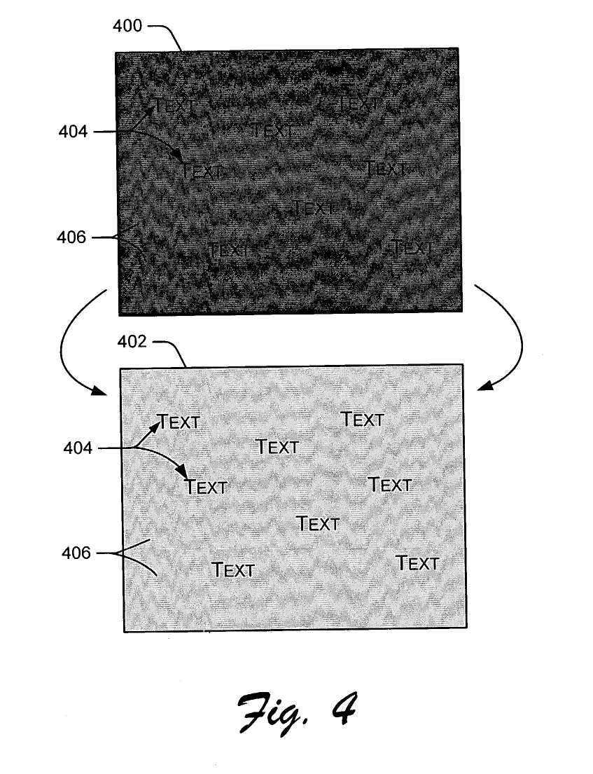

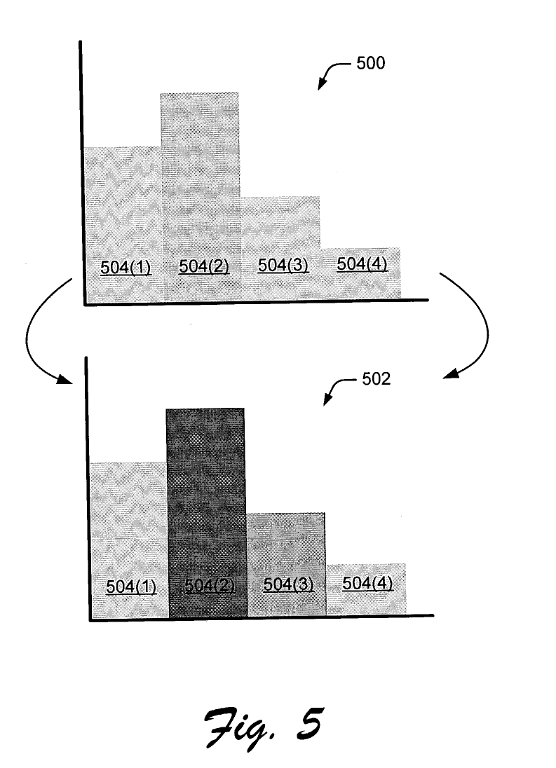

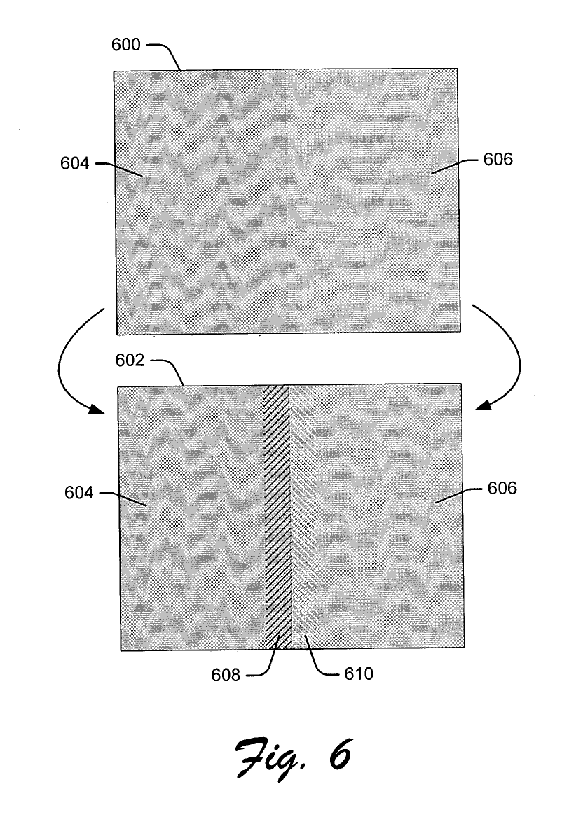

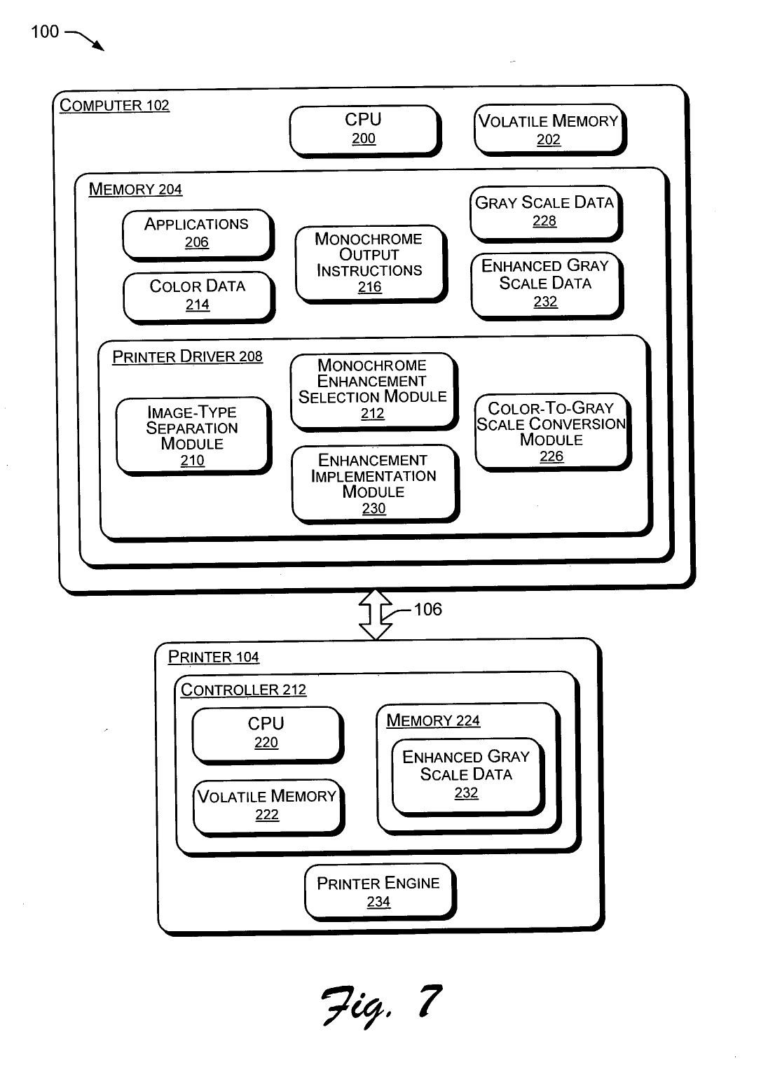

FIG. 8 is a block diagram illustrating an exemplary embodiment of a stand-alone copying device 104 that is suitable for implementation in the system environment 100 of FIG. 1. Copying device 104 is embodied as a stand-alone monochrome copier 104.

Copier 104 of the FIG. 8 embodiment includes controller 804 that, in general, processes data scanned in on scanner platen 800 to control the output of copier 104 through copier engine 802. The controller 804 typically includes a data processing unit/CPU 806, a volatile memory 808 (i.e., RAM), and a nonvolatile memory 810. Nonvolatile memory 810 can include various computer storage media such as ROM, flash memory, a hard disk, a removable floppy disk, a removable optical disk and the like. Nonvolatile memory 810 generally provides storage of computer/processor-readable instructions, data structures, program modules and other data for printer 104.

Accordingly, nonvolatile memory 810 includes color data 812, gray scale data 814, monochrome output instructions 816, enhanced gray scale data 818, and copier driver 820. Copier driver 820 includes various modules 822, 824, 826, and 828 that are similar in configuration and function to analogous modules discussed above with respect to the embodiments of FIGS. 2 and 7. Thus, color-to-gray scale conversion module 822 is generally configured to convert color data 812 into gray scale data 814, monochrome enhancement selection module 824 is configured to present a user with options for enhancing gray scale data for the various image types, image-type separation module 826 is configured to receive copy data from scanner platen 800 and format it into various image types (such as text, text on a background, vector graphics, and bitmap), and enhancement implementation module 828 that is generally configured to recognize various image types within gray scale data 814, and to enhance the gray scale data according to monochrome output instructions 816 provided for the various image types. User options that determine or set monochrome output instructions 816 are entered through a front panel (not shown) on copier 104. Gray scale data 814 and enhanced gray scale data 818 are rendered through copier engine 802.

A difference in the FIG. 8 stand-alone copier embodiment from the prior embodiments of FIGS. 2 and 7 is that the color document data is entered via scanner platen 800 rather than from an application program 206. Once the color data 812 is entered into copier 104, the gray scale enhancement process that occurs is very similar to that described above for the embodiments of FIGS. 2 and 7. In addition, the discussion above regarding the examples of gray scale enhancements to various image types in FIGS. 3-6 applies similarly to the FIG. 8 embodiment.

Exemplary Methods For Implementing Gray Scale Enhancements For Color Documents Rendered On Monochrome Devices

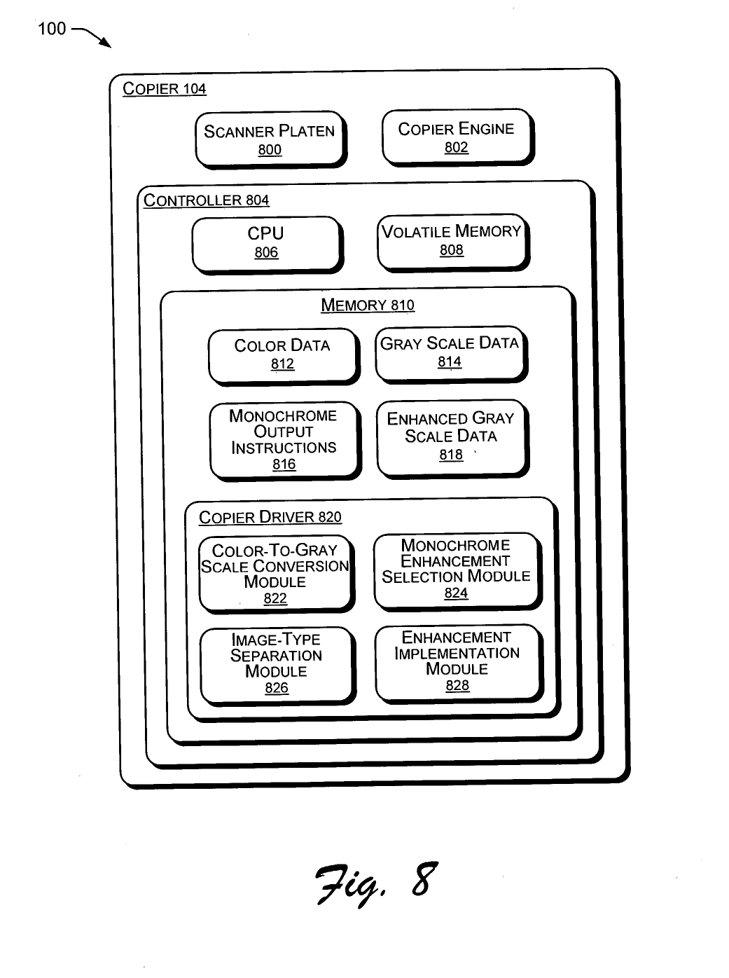

Example methods for implementing gray scale enhancements for color documents being rendered on monochrome devices (i.e., printers and copiers) will now be described with primary reference to FIGS. 9-13. The methods apply generally to the exemplary embodiments discussed above with respect to FIGS. 1-8. The elements of the described methods may be performed by any appropriate means, including, for example, by the execution of processor-readable instructions defined on a processor-readable media, such as a disk, a ROM or other such memory device.

Referring to the method illustrated in FIG. 9, at block 900, a print job is received comprising color print data. The print job is received from a computer executing an application program that generates the data in the print job. At block 902, monochrome output instructions are received. The monochrome output instructions are received from the computer based on user-selected options made through a printer driver executing on the computer. At block 904, the color print data is converted into gray scale equivalent data. At block 906, one or more image types are distinguished from within the print job or gray scale data. The image types may include text image types, text on a background image types, vector graphics image types, and bitmap image types. At block 908, the gray scale data is enhanced for each image type according to the monochrome output instructions.

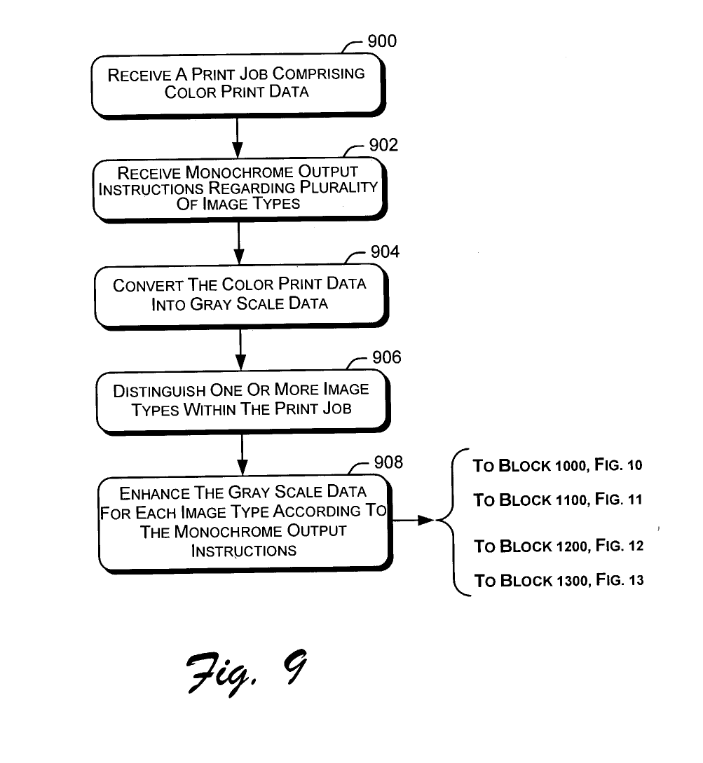

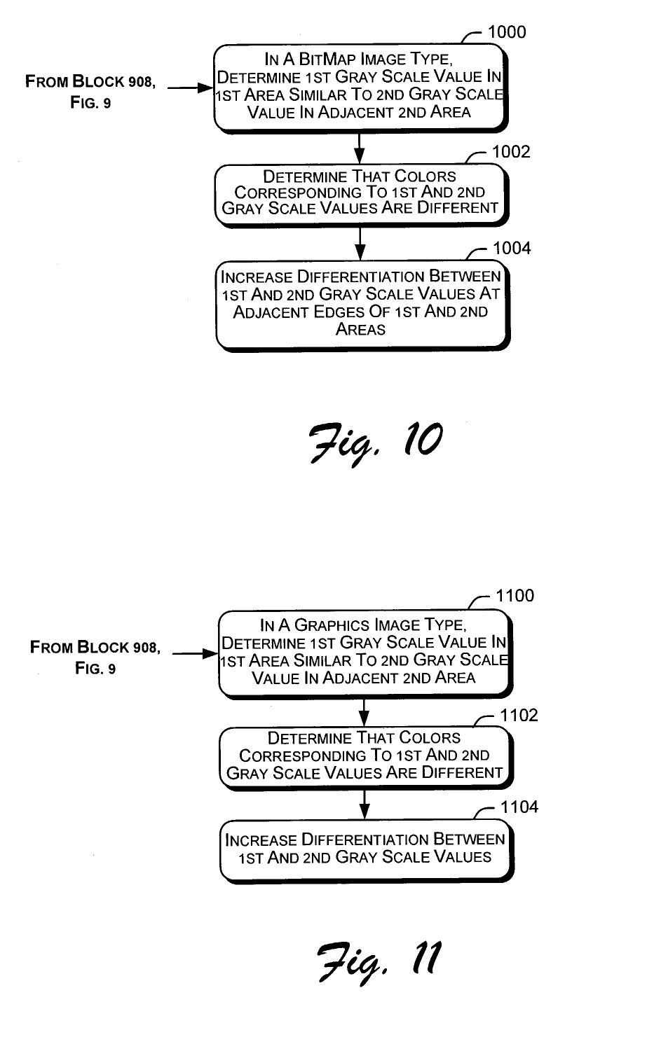

Referring now to the method illustrated in FIG. 10, which is continued from block 908 of FIG. 9, at block 1000, in a bitmap image type, a first gray scale value in a first area is determined to be similar to a second gray scale value in an adjacent second area. At block 1002, colors corresponding to the gray scale values are determined to be different. At block 1004, the differentiation between the two gray scale values is increased at the adjacent edges of the first and second areas.

Referring now to the method illustrated in FIG. 11, which is continued from block 908 of FIG. 9, at block 1100, in a vector graphics image type, a first gray scale value in a first area is determined to be similar to a second gray scale value in an adjacent second area. At block 1102, colors corresponding to the gray scale values are determined to be different. At block 1104, the differentiation between the two gray scale values is increased.

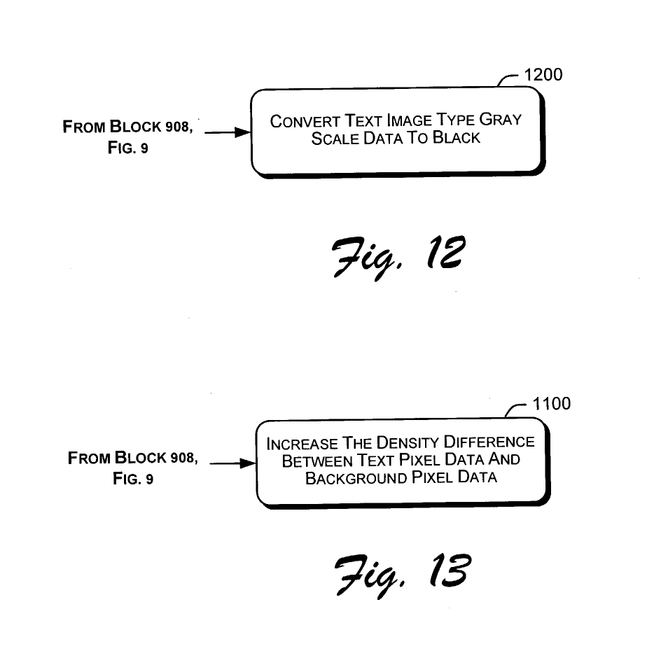

Referring now to the method illustrated in FIG. 12, which is continued from block 908 of FIG. 9, at block 1200, gray scale data of a text image type is converted to black data.

Referring now to the method illustrated in FIG. 13, which is continued from block 908 of FIG. 9, at block 1300, the density difference between text pixel data and background pixel data is increased.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

Additionally, while one or more methods have been disclosed by means of flow diagrams and text associated with the blocks of the flow diagrams, it is to be understood that the blocks do not necessarily have to be performed in the order in which they were presented, and that an alternative order may result in similar advantages.

1. A processor-readable medium comprising processor-executable instructions configured for:
receiving a print job comprising color print data;
receiving monochrome output instructions having information regarding a plurality of image types;
generating gray scale data from the color print data;
distinguishing one or more image types within the print job;
enhancing the gray scale data for each image type according to the monochrome output instructions.

2. A processor-readable medium as recited in claim 1, wherein an image type is text, the enhancing further comprising converting gray scale data for the text into black data.

3. A processor-readable medium as recited in claim 1, wherein an image type is a bitmap, the enhancing further comprising:
determining that a first gray scale value in a first area is similar to a second gray scale value in a second area, the first area and the second area being adjacent to one another;
determining that a color corresponding to the first gray scale value is different than a color corresponding to the second gray scale value; and
increasing differentiation between the first gray scale value and the second gray scale value at adjacent edges of the first area and the second area.

4. A processor-readable medium as recited in claim 3, wherein the increasing differentiation further comprises:
increasing pixel data density at edges in the first area that are adjacent to the second area; and
decreasing pixel data density at edges in the second area that are adjacent to the first area.

5. A processor-readable medium as recited in claim 1, wherein an image type is a bitmap, the enhancing further comprising:
determining that a first gray scale value in a first area is similar to a second gray scale value in a second area, the first area and the second area being adjacent to one another;
determining that a color corresponding to the first gray scale value is the same as, but of a different intensity than, a color corresponding to the second gray scale value; and
leaving the first gray scale value and the second gray scale value as they are.

6. A processor-readable medium as recited in claim 1, wherein an image type is a graphics image type, the enhancing further comprising:
determining that a first gray scale value in a first area is similar to a second gray scale value in a second area, the first area and the second area being adjacent to one another;
determining that a color corresponding to the first gray scale value is different than a color corresponding to the second gray scale value; and
increasing differentiation between the first gray scale value and the second gray scale value.

7. A processor-readable medium as recited in claim 6, wherein the increasing differentiation further comprises:
increasing pixel data density of the first area; and
decreasing pixel data density of the second area.

8. A processor-readable medium as recited in claim 6, wherein the increasing differentiation further comprises:
decreasing pixel data density of the first area; and
increasing pixel data density of the second area.

9. A processor-readable medium as recited in claim 6, wherein the increasing differentiation further comprises:
increasing pixel data density of the first area; and
leaving pixel data density of the second area at its current level.

10. A processor-readable medium as recited in claim 6, wherein the increasing differentiation further comprises:
decreasing pixel data density of the first area; and
leaving pixel data density of the second area at its current level.

11. A processor-readable medium as recited in claim 6, wherein the increasing differentiation further comprises:
leaving pixel data density of the first area at its current level; and
decreasing pixel data density of the second area.

12. A processor-readable medium as recited in claim 6, wherein the increasing differentiation further comprises:
leaving pixel data density of the first area at its current level; and
increasing pixel data density of the second area.

13. A processor-readable medium as recited in claim 1, wherein an image type is text on a background, the text having a first gray scale value and the background having a second gray scale value, the enhancing further comprising:
increasing differentiation between the first gray scale value and the second gray scale value.

14. A processor-readable medium as recited in claim 13, wherein the increasing differentiation comprises:
increasing pixel data density of the text; and
decreasing pixel data density of the background.

15. A processor-readable medium as recited in claim 13, wherein the increasing differentiation further comprises:
decreasing pixel data density of the text; and
increasing pixel data density of the background.

16. A processor-readable medium as recited in claim 13, wherein the increasing differentiation further comprises:
increasing pixel data density of the text; and
leaving pixel data density of the background at its current level.

17. A processor-readable medium as recited in claim 13, wherein the increasing differentiation further comprises:
decreasing pixel data density of the text; and
leaving pixel data density of the background at its current level.

18. A processor-readable medium as recited in claim 13, wherein the increasing differentiation further comprises:
leaving pixel data density of the text at its current level; and
decreasing pixel data density of the background.

19. A processor-readable medium as recited in claim 13, wherein the increasing differentiation further comprises:
leaving pixel data density of the text at its current level; and
increasing pixel data density of the background.

20. A processor-readable medium comprising processor-executable instructions configured for:
recognizing within a bitmap image, a first area comprising pixel data of a higher density adjacent to a second area comprising pixel data of a lower density;
determining that a density difference between the higher density and the lower density is at or below a threshold value;
determining from original color data that a color of the first area is different than a color of the second area; and
exaggerating the density difference along adjacent edges of the first area and the second area.

21. A processor-readable medium as recited in claim 20, wherein the exaggerating further comprises:
increasing pixel data density on an edge of the first area that is adjacent to the second area; and
decreasing pixel data density on an edge of the second area that is adjacent to the first area.

22. A processor-readable medium comprising processor-executable instructions configured for:
recognizing within a vector graphics image, a first graphic area comprising pixel data of a higher density adjacent to a second graphic area comprising pixel data of a lower density;
determining that a density difference between the higher density and the lower density is at or below a threshold value;
determining from original color data that a color of the first graphic area is different than a color of the second graphic area; and
increasing differentiation between the first gray scale value and the second gray scale value.

23. A processor-readable medium as recited in claim 22, wherein the increasing differentiation is a technique selected from the group of techniques comprising:
increasing pixel data density of the first graphic area and decreasing pixel data density of the second graphic area;
decreasing pixel data density of the first graphic area and increasing pixel data density of the second graphic area;
increasing pixel data density of the first graphic area and leaving pixel data density of the second graphic area at its current level;
decreasing pixel data density of the first graphic area and leaving pixel data density of the second graphic area at its current level;
leaving pixel data density of the first graphic area at its current level and decreasing pixel data density of the second graphic area; and
leaving pixel data density of the first graphic area at its current level and increasing pixel data density of the second graphic area.

24. A processor-readable medium comprising processor-executable instructions configured for:
in an image type that includes text and a background, recognizing that text pixel data has a higher density than background pixel data, the background pixel data having a lower density;
determining that a density difference between the higher density and the lower density is at or below a threshold value;
determining from original color data that a color of the text is different than a color of the background; and
increasing the density difference between the text and the background.

25. A processor-readable medium as recited in claim 24, wherein the increasing the density difference is a technique selected from the group of techniques comprising:
increasing pixel data density of the text and decreasing pixel data density of the background;
decreasing pixel data density of the text and increasing pixel data density of the background;
increasing pixel data density of the text and leaving pixel data density of the background at its current level;
decreasing pixel data density of the text and leaving pixel data density of the background at its current level;
leaving pixel data density of the text at its current level and decreasing pixel data density of the background; and
leaving pixel data density of the text at its current level and increasing pixel data density of the background.

26. A processor-readable medium comprising processor-executable instructions configured for:
receiving color print data from an application program, the color print data in an application program format;
converting the color print data from the application program format into printer data in a printer-friendly format, the printer data formatted into one or more image types;
receiving monochrome output instructions regarding a plurality of image types;
sending the printer data and the monochrome output instructions to a printer.

27. A processor-readable medium comprising processor-executable instructions configured for:
receiving a print command from within an application program;
receiving color print data from the application program, the color print data in an application program format;
presenting gray scale enhancement options for printing various image types on a monochrome printer;
accepting user selections regarding the gray scale enhancement options;
formatting the color print data into printer-friendly data, the printer-friendly data comprising one or more image types;
sending the user selections and the printer-friendly data to the monochrome printer.

28. A processor-readable medium as recited in claim 27, wherein the gray scale enhancement options comprise:
a first option to have gray scale enhancements automatically set; and
a second option to have gray scale enhancements set by a user.

29. A processor-readable medium as recited in claim 28, wherein the second option further comprises:
for text image types, an option to print text in gray scale or in black;
for graph image types, an option to increase differentiation between gray scales of graphic components whose gray scale values are similar and whose original colors are different;
for bitmap image types, an option to increase differentiation of gray scales at adjacent edges of different color areas whose gray scale values are similar; and
for text with background image types, an option to increase differentiation between gray scale values of the text and the background.

30. A processor-readable medium comprising processor-executable instructions configured for:
receiving a print command from within an application program;
receiving color print data from the application program;
receiving user-input instructions for applying gray scale enhancements to various image types;
formatting the color print data into printer-friendly data, the printer-friendly data comprising gray scale data having one or more image types;
enhancing the gray scale data based on the user-input instructions and the one or more image types;
sending enhanced gray scale data to a monochrome printer.

31. A method of enhancing gray scale data for color documents being rendered on a monochrome device, the method comprising:
receiving a print job comprising color print data;
receiving monochrome output instructions having information regarding a plurality of image types;
generating gray scale data from the color print data;
distinguishing one or more image types within the print job;
enhancing the gray scale data for each image type according to the monochrome output instructions.

32. A method of enhancing gray scale data for color documents being rendered on a monochrome device, the method comprising:
recognizing within a bitmap image, a first area comprising pixel data of a higher density adjacent to a second area comprising pixel data of a lower density;
determining that a density difference between the higher density and the lower density is at or below a threshold value;
determining from original color data that a color of the first area is different than a color of the second area; and
exaggerating the density difference along adjacent edges of the first area and the second area.

33. A method of enhancing gray scale data for color documents being rendered on a monochrome device, the method comprising:
recognizing within a vector graphics image, a first graphic area comprising pixel data of a higher density adjacent to a second graphic area comprising pixel data of a lower density;
determining that a density difference between the higher density and the lower density is at or below a threshold value;
determining from original color data that a color of the first graphic area is different than a color of the second graphic area; and
increasing differentiation between the first gray scale value and the second gray scale value.

34. A method of enhancing gray scale data for color documents being rendered on a monochrome device, the method comprising:
in an image type that includes text and a background, recognizing that text pixel data has a higher density than background pixel data, the background pixel data having a lower density;
determining that a density difference between the higher density and the lower density is at or below a threshold value;
determining from original color data that a color of the text is different than a color of the background; and
increasing the density difference between the text and the background.

35. A method of enhancing gray scale data for color documents being rendered on a monochrome device, the method comprising:
receiving a print command from within an application program;
receiving color print data from the application program;
receiving user-input instructions for applying gray scale enhancements to various image types;
formatting the color print data into printer-friendly data, the printer-friendly data comprising gray scale data having one or more image types;
enhancing the gray scale data based on the user-input instructions and the one or more image types;
sending enhanced gray scale data to a monochrome printer.

36. A printer comprising:
a conversion module configured to convert color data into gray scale data;
monochrome output instructions having information regarding a plurality of image types; and
an enhancement implementation module configured to generate enhanced gray scale data from the gray scale data based on the monochrome output instructions.

37. A printer comprising:
color data received from an input device;
gray scale data generated from the color data by a conversion module executing on the printer; and
enhanced gray scale data generated from the gray scale data by an enhancement implementation module executing on the printer.

38. A printer as recited in claim 37, wherein the enhanced gray scale data further comprises bitmap image data having at least two image areas whose adjacent edges include exaggerated gray scale data.

39. A printer as recited in claim 37, wherein the enhanced gray scale data further comprises graphics image data having at least two graphic image areas adjacent to one another, at least one of the graphic image areas comprising gray scale data with increased pixel density.

40. A printer as recited in claim 37, wherein the enhanced gray scale data further comprises graphics image data having at least two graphic image areas adjacent to one another, at least one of the graphic image areas comprising gray scale data with decreased pixel density.

41. A printer as recited in claim 37, wherein the enhanced gray scale data further comprises text image data having gray scale data that is a shade of black.

42. A printer as recited in claim 37, wherein the enhanced gray scale data further comprises text on a background image data, wherein a gray scale shade of the text is darkened and a grayscale shade of the background is lightened.

43. A printer as recited in claim 37, wherein the enhanced gray scale data further comprises text on a background image data, wherein a gray scale shade of the text is lightened and a grayscale shade of the background is darkened.

44. A computer comprising:
color print data;
an image-type separation module configured to separate image types within the color print data;
an enhancement selection module configured to provide enhancement options for various image types; and
monochrome output instructions generated by the enhancement selection module according to user-selected enhancement options.

45. A computer as recited in claim 44, further comprising a conversion module configured to convert the color print data into gray scale data.

46. A computer as recited in claim 45, further comprising an enhancement implementation module configured to generate enhanced gray scale data from the gray scale data based on the monochrome output instructions.

47. A copier comprising:
a conversion module configured to convert color data into gray scale data;
monochrome output instructions; and
an enhancement implementation module configured to generate enhanced gray scale data from the gray scale data based on the monochrome output instructions.

48. A copier comprising:
a scanner platen;
color data received through the scanner platen;
a conversion module configured to convert the color data into gray scale data;
an enhancement implementation module configured to enhance the gray scale data into enhanced gray scale data; and
a copier engine configured to generate a hard-copy image of the enhanced gray scale data.

49. A copier as recited in claim 48, further comprising:
an image-type separation module configured to separate image types within the color data;
an enhancement selection module configured to provide enhancement options for various image types; and
monochrome output instructions generated by the enhancement selection module according to user-selected enhancement options.
